(19) United States
(12) Patent Application Publication
(10) Pub. No.: US 2009/0250571 A1
(43) Pub. Date: Oct. 8, 2009

(54) Telescoping Leg Lock and Portable Elevated Platform with Same

(76) Inventor: David J. Laws, Provo, UT (US)

Correspondence Address: THORPE NORTH & WESTERN, LLP., P.O. Box 1219, SANDY, UT, 84091-1219, US

(21) Appl. No.: 12/098,955

(22) Filed: Apr. 7, 2008

(51) Int. Cl. F16M 11/26

(52) U.S. Cl. 248/188.5; 248/188.8

(57) ABSTRACT

A telescoping leg for supporting an elevated platform includes an outer leg. An inner leg is slidably disposed within the outer leg. An off-axis slot is disposed through a sidewall of one of either the inner leg or the outer leg and an aperture is disposed in the other. The inner leg is slidably positionable within the outer leg to align the off-axis slot with the aperture. A pin is disposable through the aperture and the slot when the aperture and the slot are aligned such that a bearing surface of the pin contacts a bearing surface of the slot to laterally push the inner leg against the outer leg.

### RELATED APPLICATIONS

This application is related to U.S. patent application Ser. No. ______, filed Apr. 7, 2008, entitled “Portable Elevated Platform with Locking Legs” as TNW Docket Number 00538-32685; and U.S. patent application Ser. No. ______, filed Apr. 7, 2008, entitled “Portable Elevated Platform” as TNW Docket Number 00051-32686; which are herein incorporated by reference in their entirety for all purposes.

### BACKGROUND OF THE INVENTION

1. Field of the Invention

The present invention relates generally to telescoping legs for portable elevated platforms such as stages, risers, tables, chairs, scaffolding, and the like.

2. Related Art

Many portable elevated platforms such as portable stages, risers, tables, chairs, scaffolding and the like have extendible legs that can be adjusted to place the platform at a variety of heights. Such legs are often telescoping legs with an inner leg slidably disposed into a hollow outer leg. The inner leg can slide within the outer leg to lengthen the leg. Thus, when a higher platform is desired, the inner leg can be slid out of the outer leg and locked into place. Similarly, when an inner platform is desired, the inner leg can be slid into the outer leg and locked into place.

One type of locking device for such legs includes a pin that can slide through holes in the inner and outer legs. To lock the leg, the holes in the inner leg are aligned with the holes in the outer leg and the pin is slid through the holes to prevent movement of the inner leg with respect to the outer leg.

It will be appreciated that in order for the inner leg to slide within the outer leg, the inner leg must have a smaller cross sectional area than the outer leg. Often, this cross sectional area difference is large enough that the inner leg can move laterally inside the outer leg in addition to sliding longitudinally within the outer leg. Unfortunately, the pin lock described above, while adequate at restricting sliding movement of the inner leg with respect to the outer leg, usually does not prevent lateral movement of the inner leg inside the outer leg. Consequently, the legs can shift slightly when the platform is loaded, or the load on the platform moves. This shifting can cause creaking and rattling of the portable platform. Additionally, lateral shifting of the inner leg can cause an unsteady feeling to people standing on the platform because the platform is moving.

Another type of locking device for telescoping legs includes a threaded set screw that extends through the outer leg and pushes the inner leg against the outer leg so as to clamp the inner leg into place. Unfortunately, such set screws or other similar threaded fasteners are time consuming to properly engage because they have to be rotated until the set screw engages the inner leg with sufficient force to hold the inner and outer legs in position when a load is placed on the leg. Additionally, dynamic loading on the leg, or increasing the weight of the load can sometimes cause the set screw to slip along the inner leg which can result in a collapse or partial collapse of the leg during use. Moreover, this loading can move the inner leg and make relative sliding between the legs increasingly difficult.

### SUMMARY OF THE INVENTION

The inventors of the present invention have recognized that it would be advantageous to develop an extendible leg for an elevated platform with reduced noise. Additionally, the inventors of the present invention have recognized that it would be advantageous to develop a method and device for locking a telescoping leg at a predetermined height and to increase stability and reduce shifting of the legs.

The invention provides a telescoping leg for supporting an elevated platform including an outer leg coupled to the elevated platform. An inner leg can be slidably disposed with respect to the outer leg. At least one off-axis slot can be disposed through a sidewall of one of either the inner leg or the outer leg and an aperture can be disposed in the other one of the inner leg or outer leg. The inner leg can be slidably positionable with respect to the outer leg to align the at least one off-axis slot with the at least one aperture. A pin can be disposed through the at least one aperture and the at least one off-axis slot when the aperture and the slot are aligned such that a bearing surface of the pin can contact a bearing surface of the at least one off-axis slot to laterally push the outer leg against the outer leg.

The present invention also provides for a method for reducing movement and noise of a telescoping leg for an elevated platform when a load is placed on the raised platform. The method can include sliding an inner leg with respect to an outer leg to a desired length. An aperture in one of the inner leg or the outer leg can be aligned with an off-axis slot in the other of the inner leg or outer leg. A pin can be placed through the aperture and off-axis slot. An applied load can be placed on the telescoping leg such that a bearing surface of the pin can contact a bearing surface of the off-axis slot. The force of the pin against the bearing surface of the off-axis slot can push the inner leg against the outer leg to reduce movement of the inner leg with respect to the outer leg.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a side view of a telescoping leg in accordance with an embodiment of the present invention;

FIG. 2 is a fragmentary side view of the telescoping leg of FIG. 1 with an off-axis slot disposed in an inner leg;

FIG. 3 is a fragmentary side view of the telescoping leg of FIG. 1 with an off-axis slot disposed in an outer leg;

FIG. 4 is a fragmentary cross section view of the telescoping leg of FIG. 1, shown in an unloaded configuration;

FIG. 5 is a fragmentary cross section view of the telescoping leg of FIG. 1, shown in a loaded configuration;

FIG. 6 is a top cross sectional view of the telescoping leg of FIG. 1, showing a burr groove in the inner and outer legs;

FIG. 7 is a longitudinal cross sectional view of the telescoping leg of FIG. 1, showing the burr groove extending longitudinally along the inner and outer legs; and

FIG. 8 is a fragmentary longitudinal cross sectional view of the telescoping leg of FIG. 1, showing the burr groove extending longitudinally along the inner and outer legs.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for an extendible leg for a portable elevated platform such as a portable stage, riser, scaffolding, and the like. The extendible leg can be a telescoping leg having an inner leg slidably associated with a hollow outer leg. In one aspect, the inner leg can slide out of the outer leg to make the leg longer. Similarly, the inner leg can slide into the outer leg to make the leg shorter. The outer leg can be coupled to the elevated platform. An off axis slot can be disposed in a side wall of either the outer leg or the inner leg. The off axis slot can have a longitudinal axis that is askew at a predetermined angle α with respect to a longitudinal axis of the leg. An aperture can be disposed in the other of the outer or the inner leg. The off-axis slot and the aperture can be aligned by sliding the inner leg into or out of the outer leg. A pin can be placed through the aligned off-axis slot and the aperture to restrict the inner leg from sliding within the outer leg. A bearing surface of the pin can rest against a bearing surface of the off-axis slot so that when a load is placed on the elevated platform, the weight of the load and the platform can push the bearing surface of the pin along the bearing surface of the off-axis slot so that the pin moves along the axis of the off axis slot. In this way, the pin can move the inner leg laterally within the outer leg until the inner leg is wedged against an inner sidewall of the outer leg. Additionally, the pin and the off axis slot can restrict further lateral movement of the inner leg with respect to the outer leg in order to reduce noise and movement from the telescoping leg.

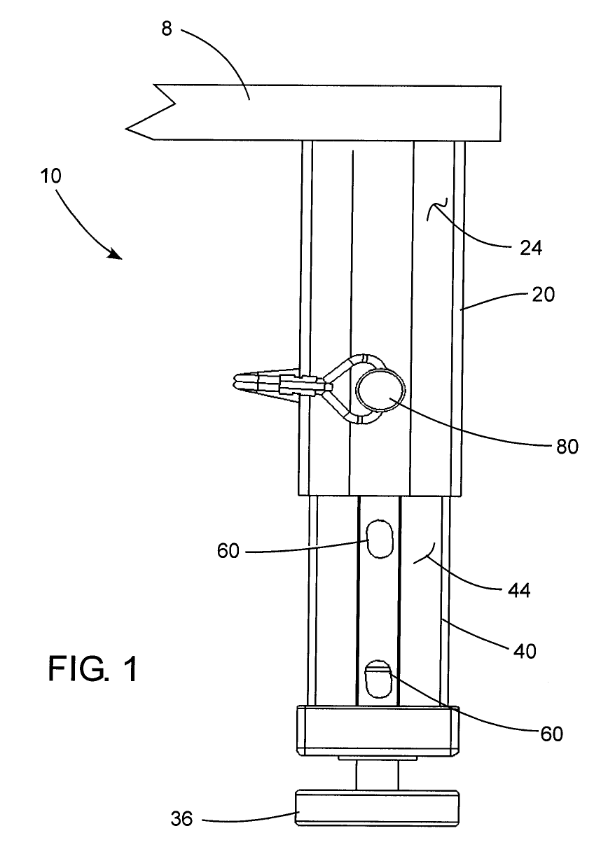

As illustrated in FIGS. 1-4, a telescoping leg, indicated generally at 10, in accordance an embodiment of the present invention shown for use in supporting a portable elevated platform 8 such as a portable stage, riser, scaffold, and the like. As used herein, the term portable elevated platform means any type of platform used for supporting standing or walking people. For example, a portable elevated platform can be a performance stage, a dance stage, choral risers, baker scaffolding, scaffolding, and the like.

The telescoping leg 10 can include an outer leg 20 and an inner leg 40. In one aspect, the outer leg can be a hollow shaft forming an outer, hollow outer leg. Similarly, the inner leg can be an inner shaft slidably disposed inside the outer, hollow outer leg. The leg 10 can also have a foot 36.

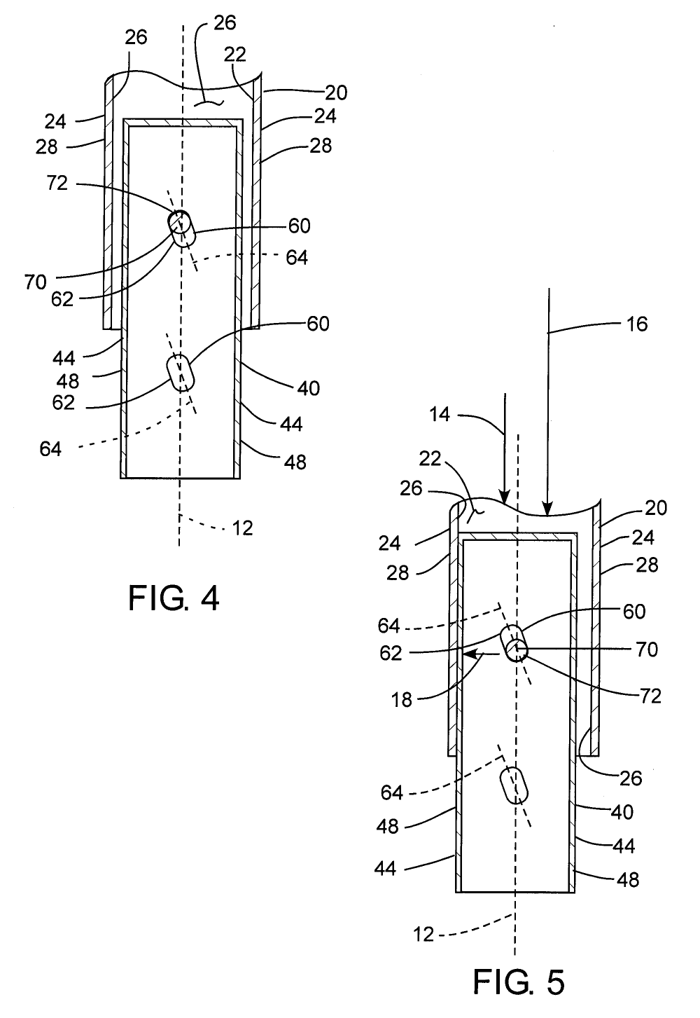

The outer leg 20 can be coupled to the portable elevated platform 8. The outer leg 20 can be formed of suitable structural material such as metal, structural polymers, composite materials, and the like. The outer leg 20 can have a hollow interior space 22 (FIG. 4) and at least one sidewall 24 substantially circumscribing and enclosing the hollow interior space 22. In one aspect, the outer leg 20 can be quadrangular in shape having 4 connected sidewalls 24. The sidewalls 24 of the outer leg 20 can have an internal surface 26 and an external surface 28, as best seen in FIG. 4. It will be appreciated that the outer leg can have different configurations, such as C-channels, square tubes, circular tubes, angle stock, and the like.

Referring again to FIGS. 1-4, the inner leg 40 can be slidably disposed within the hollow interior space 22 of the hollow outer leg 20. The inner leg 40 can also be formed of a suitable structural material such as metal, structural polymers, composite materials, and the like. Similar to the outer leg, it will be appreciated that the inner leg can have different configurations, such as C-channels, square tubes, circular tubes, angle stock, and the like.

In one aspect, the inner leg 40 can be similarly shaped as the outer leg 20. Thus, in the case where the outer leg 20 is quadrangular having four connected sidewalls 24, the inner leg 40 can also be quadrangular having 4 connected sidewalls 44. The sidewalls 44 of the inner leg 40 can have external surfaces 48. The external surfaces 48 of the inner leg 40 can slide and rest against the internal surfaces 26 of the sidewalls 24 of the outer leg 20.

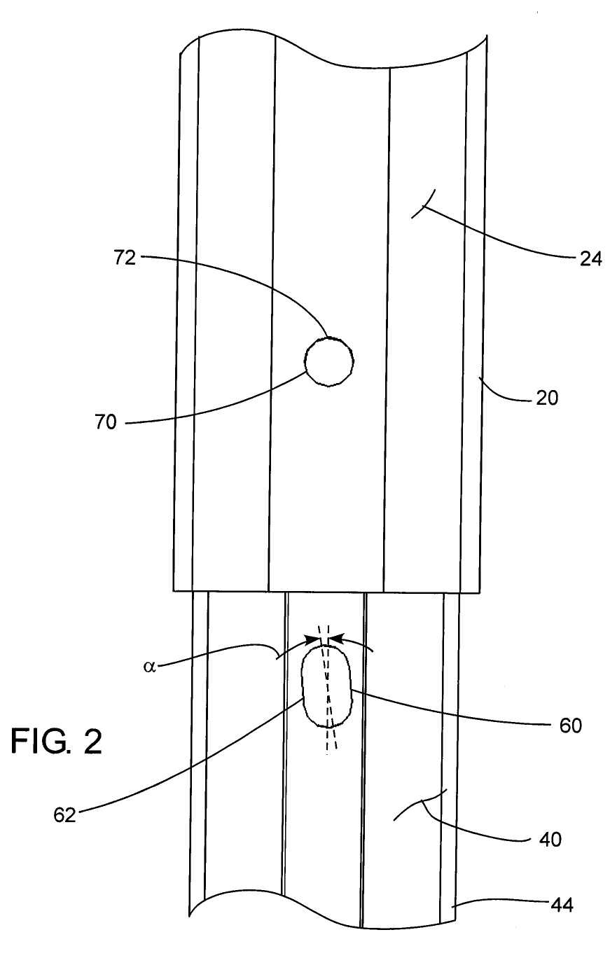

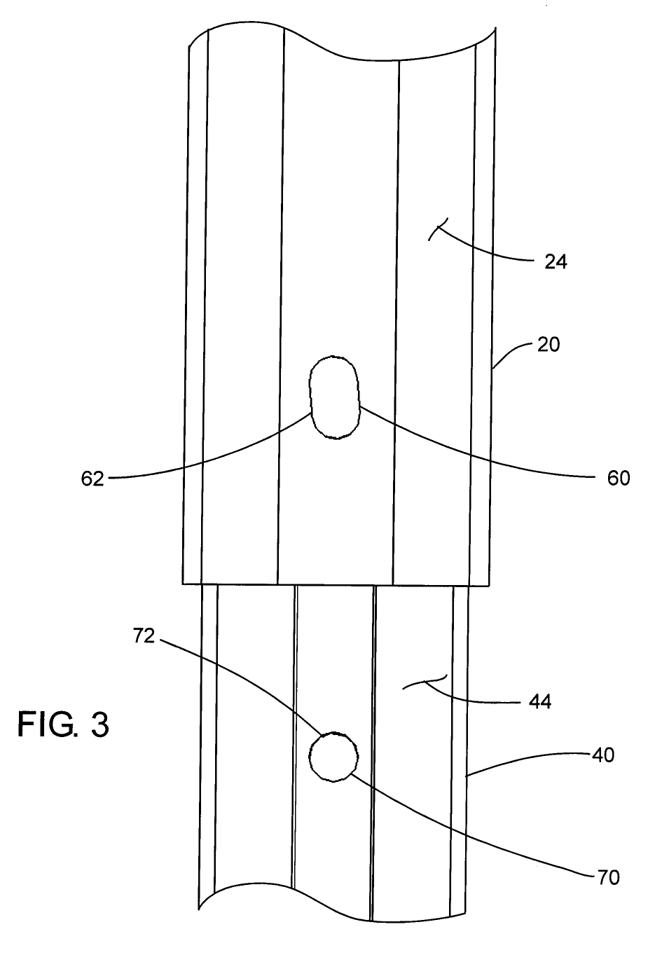

At least one off-axis slot 60 can be disposed through a sidewall 24 or 44 of one of either the inner leg 40 or the outer leg 20. In one aspect, the off-axis slot 60 can be disposed in the inner leg 40, as shown in FIGS. 1-2. In another aspect, the off-axis slot 60 can be disposed in the outer leg 20, as shown in FIG. 3. In either case, the off-axis slot can be oriented askew at a predetermined angle α to a longitudinal axis of the legs.

The off-axis slot 60 can have a bearing surface 62 and a longitudinal axis, indicated by dashed lines at 64. The longitudinal axis 64 of the off-axis slot 60 can be oriented at an acute angle with respect to a longitudinal axis, indicated by dashed lines at 12 of the telescoping leg 10. In one aspect, the longitudinal axis 64 of the off-axis slot 60 can be rotated at an angle of about 1 to 5 degrees with respect to the longitudinal axis 12 of the telescoping leg 10.

An aperture 70 can be disposed in a corresponding sidewall 24 or 44 in the other one of the inner leg 40 or the outer leg 20. Thus, in one aspect, the aperture 70 can be disposed in the outer leg 20, as shown in FIGS. 1-2, and, in another aspect, the aperture 70 can be disposed in the inner leg 40, as shown in FIG. 1.

In one embodiment, the aperture 70 can be a substantially circular hole that extends through the sidewall 24 or 44 of the inner leg or the outer leg. The aperture or hole 70 can have a bearing surface 72. The inner leg 40 can be slid within the outer leg 20 to align the off-axis slot 60 with the at least one aperture 70. For purposed of this application, the term “pin” is used broadly and can include any member disposed through the aperture and the slot, such as a rod, detent, spring pin, bolt, screw, and the like.

A pin 80 can be disposed through the aperture 70 and the off-axis slot 60 when the aperture and the slot are aligned. The pin 80 can be a cotter pin, a bearing pin, a shear pin, a spring pin, or the like. The pin 80 can have a bearing surface 82 that can contact and bear on the bearing surface 62 of the off-axis slot 60 and the bearing surface 72 of the aperture 70.

Referring to FIGS. 4-5, in use, an aperture 70 can be aligned with an off-axis slot 60 and a pin 80 can be placed through the aperture and the off-axis slot, as shown in FIG. 4. As seen in FIG. 5, when the leg 10 is supporting the platform, the weight of the platform, indicated by the arrow at 14, can press the bearing surface 72 of the aperture 70 downward on the bearing surface 82 of the pin 80. Similarly, when a load, indicated by the arrow at 16, is placed on the elevated platform, the weight of the load and the weight of the platform can push the bearing surface 72 of the aperture 70 downward on the bearing surface 82 of the pin 80. With the pin 80 being pushed downward, the bearing surface 82 of the pin 80 can contact and push downward along the bearing surface 62 of the off-axis slot 60. Because the longitudinal axis 64 of the slot 60 is at an angle with respect to the longitudinal axis 12 of the leg 10, at least a portion of the downward force exerted by the bearing surface 82 of the pin 80 on the bearing surface 62 of the slot 60 is translated to a substantially horizontal or lateral force, indicated generally by an arrow at 18, on the inner leg 40. This lateral force 18 can move the inner leg 40 laterally within the outer leg 20 until the external surface 48 of the sidewall 44 of the inner leg 40 is wedged against the internal surface 26 of a corresponding sidewall 24 of the outer leg 20. In this way, the pin 80 and the off-axis slot 60 can restrict lateral movement of the inner leg 40 with respect to the outer leg 20, and, thus, reduce movement and noise in the telescoping leg 10.

The telescoping leg 10 of the present invention has several particular advantages. For example, as discussed above, the wedging action of the off axis slot and pin force the inner leg against the outer leg and reduce racking noise and movement. Additionally, the pin can be quickly inserted through the aligned off axis slot and aperture to allow efficient and timely set up of the telescoping leg, as opposed to the relatively time consuming rotation of a threaded type fastener or set screw.

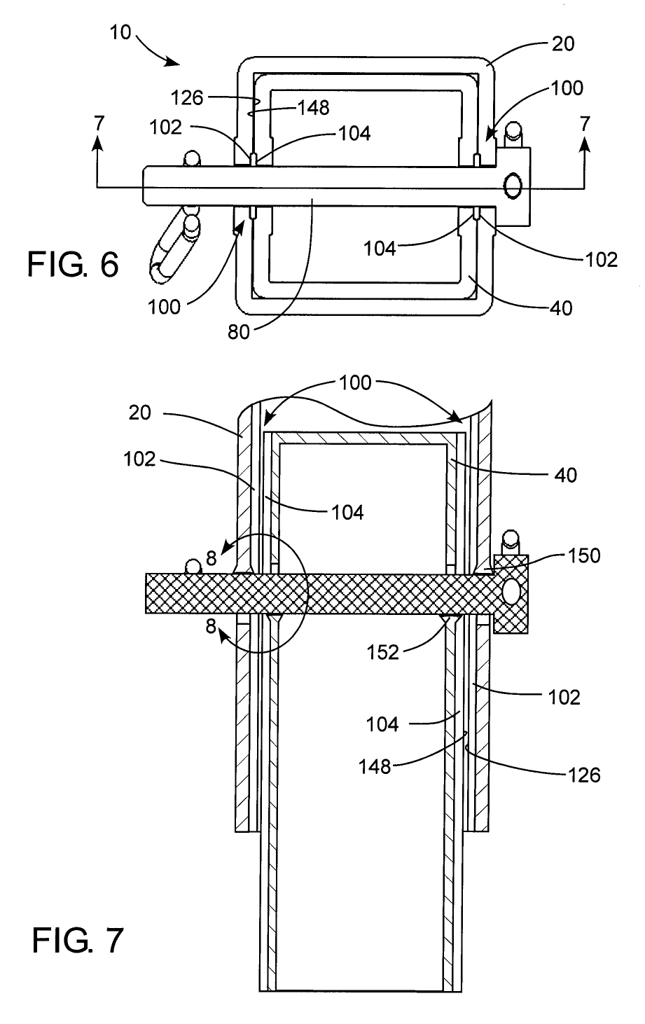

Turning to FIGS. 6-8, the telescoping leg can also have a burr groove, indicated generally at 100. The burr groove 100 can be formed by a channel 102 extending longitudinally along an inner wall 126 of the outer leg 20 and a mating channel 104 extending longitudinally along an outer wall 148 of the inner leg 40. The outer wall 148 of the inner leg 40 can correspond to the inner wall 126 of the outer leg 20. The channel 102 in the outer leg 20 can be positioned adjacent the mating channel 104 in the inner leg 40. In this way, the channel 102 in the inner wall 126 of the outer leg 20 can align with the mating channel 104 in the outer wall 148 of the inner leg 40 in order to form the burr groove 100 between the outer leg and inner leg. The channels 102 and 104, or burr groove 100, can be aligned with the slot 60.

Advantageously, the burr groove 100 can reduce the likelihood of binding between the inner leg 40 and the outer leg 20. It will be appreciated that the inner and outer legs can be formed of a relatively light weight but soft metal such as aluminum. When the telescoping leg 10 is set at a desired height, and the pin 80 is placed through the aperture 70 and the slot 60 in the telescoping leg 10, the weight of the platform 8 and any additional loading placed on the platform, such as from people walking on the platform, can be transferred to the interface between the pin 80 and the aperture 70 and slot 60 in the inner leg 40 and the outer leg 20.

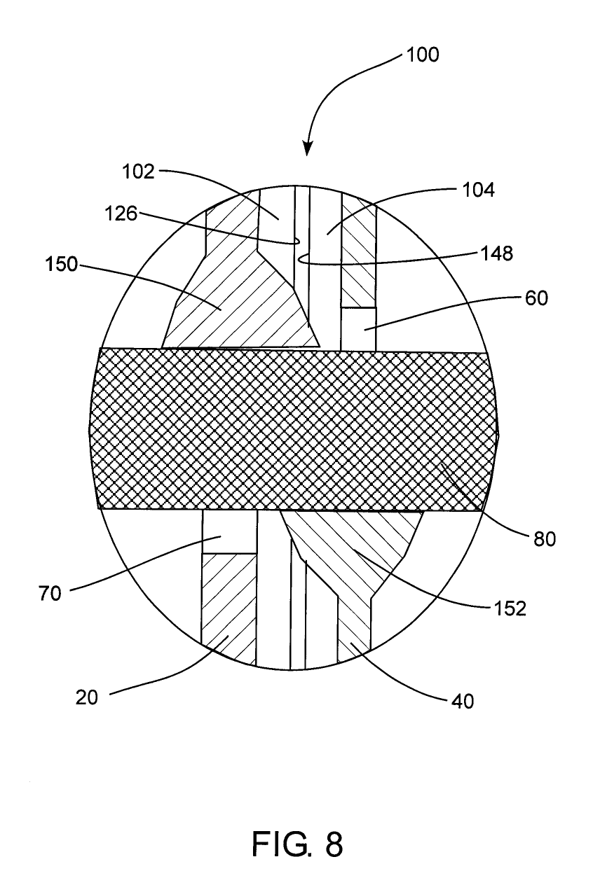

Because this loading can exceed the strength of the aluminum, a burr 150 can form in the outer leg 20 and another burr 152 can form on the inner leg 40, as seen in FIGS. 7-8. The burrs 150 and 152 can protrude away from the sidewall 126 of the outer leg 20 and the sidewall 148 of the inner leg 40. When these burrs 150 and 152 form between the inner and outer legs, the burrs can bind the inner leg 40 against the outer leg 20 causing the inner leg to be difficult to move relative to the outer leg. Thus, the burr groove 100 can be sized and shaped to create a passageway for the burrs 150 and 152 in order to allow the burrs to move without contacting the mating leg when the telescoping leg extended or retracted.

The present invention also provides for a method for reducing movement and noise of a telescoping leg for an elevated platform when a load is placed on the raised platform. The method can include sliding an inner leg within an outer leg to a desired length. An aperture in one of the inner leg or the outer leg can be aligned with an off-axis slot in the other of the inner leg or outer leg. A pin can be placed through the aligned aperture and off-axis slot. An applied load can be placed on the telescoping leg such that a bearing surface of the pin can contact a bearing surface of the off-axis slot. The force of the pin against the bearing surface of the off-axis slot can push the inner leg against the outer leg to reduce movement of the inner leg with respect to the outer leg.

The method can also include removing the pin from the aligned aperture and off-axis slot. The aperture can be aligned with a different off-axis slot to change the length of the telescoping leg. The pin can be placed through the aligned aperture and the different off-axis slot.

The method can also include supporting a portable elevated platform with the telescoping leg.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A telescoping leg for supporting an elevated platform, comprising:
a) an outer leg couplable to the elevated platform;
b) an inner leg slidably disposed with respect to the outer leg;
c) at least one off-axis slot disposed through a sidewall of one of either the inner leg or the outer leg and corresponding to at least one aperture in the other one of the inner leg or outer leg, the inner leg being slidable with respect to the outer leg to align the at least one off-axis slot with the at least one aperture, the off-axis slot oriented askew to a longitudinal axis of the legs; and
d) a pin disposable through the at least one aperture and the at least one off-axis slot when the aperture and the slot are aligned.

2. A leg in accordance with claim 1, wherein a bearing surface of the pin contacts a bearing surface of the at least one off-axis slot to push the inner leg against the outer leg.

3. A leg in accordance with claim 1, wherein the at least one off-axis slot is disposed in a sidewall of the inner leg and the at least one aperture is disposed in a sidewall of the outer leg.

4. A leg in accordance with claim 1, wherein the at least one off-axis slot is disposed in a sidewall of the outer leg and the at least one aperture is disposed in a sidewall of the inner leg.

5. A leg in accordance with claim 1, wherein a longitudinal axis of the slot is oriented at an acute angle with respect to the longitudinal axis of the legs.

6. A leg in accordance with claim 1, wherein a longitudinal axis of the slot is oriented at an angle of about 1 to 5 degrees with respect to a longitudinal axis of the legs.

7. A leg in accordance with claim 1, wherein an elevated platform is couplable to the outer leg.

8. A leg in accordance with claim 1, further comprising:
a) a channel extending longitudinally along an inner wall of the outer leg;
b) a mating channel extending longitudinally along an outer wall of the inner leg, the outer wall of the inner leg corresponding to the inner wall of the outer leg; and
c) the channel in the inner wall of the outer leg being aligned with the mating channel in the outer wall of the inner leg to form a burr groove between the outer leg and inner leg.

9. A telescoping leg for supporting an elevated platform, comprising:
a) an outer leg couplable to the elevated platform and having at least one aperture through a sidewall;
b) an inner leg slidably disposed within the outer leg;
c) at least one off-axis slot disposed through a sidewall of the inner leg, the inner leg being slidably positionable within the outer leg to align the at least one off-axis slot in the inner leg with the at least one aperture in the outer leg; and
d) a pin disposable through the at least one aperture in the outer leg and the at least one slot in the inner leg when the aperture and the slot are aligned such that a bearing surface of the pin contacts a bearing surface of the at least one slot to laterally push the inner leg against the outer leg.

10. A leg in accordance with claim 9, wherein a longitudinal axis of the slot is oreinted at an acute angle with respect to a longitudinal axis of the legs.

11. A leg in accordance with claim 9, wherein a longitudinal axis of the slot is oriented at an angle of about 1-5 degrees with respect to a longitudinal axis of the legs.

12. A leg in accordance with claim 9, wherein an elevated platform is couplable to the outer leg.

13. A leg in accordance with claim 9, further comprising:
a) a channel extending longitudinally along an inner wall of the outer leg;
b) a mating channel extending longitudinally along an outer wall of the inner leg, the outer wall of the inner leg corresponding to the inner wall of the outer leg; and
c) the channel in the inner wall of the outer leg being aligned with the mating channel in the outer wall of the inner leg to form a burr groove between the outer leg and inner leg.

14. A method for reducing movement and noise of a telescoping leg for an elevated platform when a load is placed on the elevated platform, comprising:
a) sliding an inner leg with respect to an outer leg to a desired length;
b) aligning an aperture in one of the inner leg or the outer leg with an off-axis slot in the other of the inner leg or outer leg;
c) placing a pin through the aperture and off-axis slot; and
d) placing an applied load on the telescoping leg such that a bearing surface of the pin contacts a bearing surface of the off-axis slot to the force the pin against the bearing surface of the off-axis slot and push the inner leg against the outer leg.

15. A method in accordance with claim 14, further comprising:
a) removing the pin from the aligned aperture and off-axis slot;
b) aligning the aperture with a different off-axis slot to change the desired length; and
c) placing the pin through the aperture and a different off-axis slot.

16. A method in accordance with claim 14, further comprising:
a) supporting a portable elevated platform with the telescoping leg.
